(19) United States
(12) Patent Application Publication
(10) Pub. No.: US 2022/0177607 A1
(43) Pub. Date: Jun. 9, 2022

(54) INULIN COMPOSITION AND METHOD OF PURIFYING INULIN

(71) Applicant: Sensus B.V., Roosendaal (NL)

(72) Inventors: Bartholomeus Mattheus de Roode, Rotterdam (NL); Margaretha Johanna de Wit, Oosterhout (NL); Johan van den Bergh, Dordrecht (NL); Max Cornelis Adrianus Maria Michielsen, Baarle-Nassau (NL)

(73) Assignee: Sensus B.V., Roosendaal (NL)

(21) Appl. No.: 17/435,418

(22) PCT Filed: Mar. 9, 2020
(86) PCT No.: PCT/EP2020/056179

§ 371 Date: Sep. 1, 2021

(30) Foreign Application Priority Data
Mar. 8, 2019 (EP) 19161624.2

(51) Int. Cl. C08B 37/00; B01D 61/02

(52) U.S. Cl. CPC C08B 37/0054; B01D 2311/08; B01D 61/027; C08B 37/0003

(57) ABSTRACT

The present invention relates to a method for purifying an aqueous liquid comprising inulin, in particular chicory root inulin, and one or more impurities, said method comprising filtration of said aqueous liquid employing a nanofiltration membrane having a molecular weight cut-off value of less than 2 kDa, without employing ion-exchange treatment. The invention further relates to the inulin composition obtainable by the method and to inulin compositions which comprise low concentrations of impurities while comprising significant amounts of short-chain (low DP) inulin.

### FIELD OF THE INVENTION

The present invention relates to a method for purifying an aqueous liquid comprising inulin, in particular comprising chicory root inulin, and several impurities. The invention further relates to the inulin composition obtainable by the method and to inulin compositions which comprise low concentrations of said impurities while still comprising significant amounts of short-chain (low DP) inulin, long-chain (high DP) inulin, minerals and organic acids. The invention also concerns alimentary products comprising said inulin compositions and specific uses of said inulin compositions.

### BACKGROUND OF THE INVENTION

Inulins are a group of naturally occurring polysaccharides which have many known uses, for example as a prebiotic, as a low-caloric dietary fiber or as a gelling agent in foodstuff. Inulins are linear chains consisting of fructose units connected via a β (2-1) bond, which typically have a terminal glucose unit. The number of monosaccharide units is commonly referred to as the degree of polymerization (DP) and typically ranges from 3 to 80. Chicory inulin typically comprises 20-35% DP3-DP9 inulin and 65-80% DP10 and higher inulin.

Inulins are most commonly extracted from plant material, such as chicory root which typically contains 70-80% (dry weight) of inulins. Inulin compositions which have a chain length distribution which resembles that of the inulin as present in the plant material, most notably characterized by the presence of both short chain inulins (e.g. with a DP of 2-10 or 2-6) and long chain inulins (e.g. with a DP of 11-60 or 7-60), are sometimes referred to as ‘native inulin’. Native inulin compositions have been associated with beneficial effects, such as prebiotic effects.

Industrial scale inulin production typically involves hot water extraction of sliced plant material, followed by purification of the crude extract and isolation of the inulin. The production of inulin from chicory root poses specific challenges because of the presence of large amounts of sesquiterpene lactones, which are not significantly present in other inulin sources such as e.g. Jerusalem Artichoke. Sesquiterpene lactones, and more specifically the lactucin-type sesquiterpene lactones, have an undesirable, bitter taste.

Purification of the crude extract is almost exclusively done by ion-exchange treatment combined with active carbon filtration. The use of ion-exchange resins and the consequential need for their regeneration has a considerable negative environmental impact. Regenerating ion-exchange resins consumes large amounts of energy and reagents such as strong acids or bases, which results into a large carbon footprint for commercially available inulin products. Additionally, the ion-exchange treatment results in the (or too much) removal of nutritionally valuable compounds naturally present in the plant material, such as minerals and organic acids, while sugars remain present in the final inulin composition. The presence of sugars is undesirable in view of the current consumer demand for low sugar products.

Isolation of inulin from the extract by crystallization may in some circumstances lead to a sesquiterpene-lactone-free and sugar-free product without requiring ion-exchange treatment, but this has the disadvantage that short chain inulin is lost as these mostly remain in solution. Hence, the crystallized end product does not reflect the ‘native’ inulin, as it typically contains even less than 0.5 wt. % of DP3-5 inulin (by weight of inulin).

Berghofer et al. (E. Berghofer et al., “Pilot-scale production of inulin from chicory roots and its use in foodstuffs.” Studies in Plant Science. Vol. 3. Elsevier, 1993. 77-84) describe the isolation of inulin from raw juice obtained after extraction of sliced chicory roots by ultrafiltration over a 5 kDa membrane and subsequent spray-drying of the retentate. Berghofer et al. note that the greater part of the ash (minerals) passed into the permeate and describes samples containing major impurities as having a bitter taste. Berghofer et al. also describe that ultrafiltration enriches higher molecular weight inulin, stating that the average DP was found to be as high as 40-45 (compared to 20-25 for samples obtained from the same plant material through crystallization).

U.S. Pat. No. 5,968,365 discloses a process for separating a first aqueous inulin solution containing carbohydrates having a range of degrees of polymerization into fractions having different average degrees of polymerization, which process comprises subjecting an aqueous inulin solution to ultrafiltration through a membrane having a predetermined pore size whereby inulin fractions having average degrees of polymerization less than a predetermined value pass through said membrane permeate and inulin fractions having average degrees of polymerization greater than said predetermined value are collected as retentate.

U.S. Pat. No. 5,254,174 discloses physical separation processes to reduce the amount of fructose, glucose and sucrose in a juice or syrup comprising fructose, glucose, sucrose and oligosaccharides. The lowest amount of sucrose+glucose+fructose achieved from a juice or syrup obtained from Jerusalem artichoke is described in example 4, wherein nanofiltration and ion-exchange chromatography treatments are applied and is 3% by weight of dry matter (3,33% by weight of inulin). Example 2 describes the use of nanofiltration alone, resulting in a sucrose+glucose+fructose content of 12% by weight of dry matter (13,33% by weight of inulin) from a juice or syrup obtained from Jerusalem artichoke.

CN102504048, CN106947006 and CN108424478 disclose processes wherein aqueous inulin extracts are purified using a process comprising ion-exchange treatment.

EP0787745A2 discloses processes wherein aqueous inulin extracts are purified. In Option I of the processes, inulin with DP>40 is removed and ion-exchange treatment is applied. In Option II of the processes, ion-exchange treatment is applied.

There is thus a need to provide an economically feasible method for purifying an aqueous liquid comprising inulin and one or more impurities, which is capable of reducing or removing impurities such as lactucins and sugars while preserving low DP inulin, high DP inulin, and preferably also nutritionally valuable compounds naturally present in the plant material, such as minerals and organic acids, and which may be characterized by a reduced environmental impact. There is also a need to provide more nutritionally optimized inulin compositions, such as inulin compositions comprising low DP inulin and high DP inulin (like in native inulin), while comprising low amounts of sugars and preferably substantial amounts of minerals and organic acids compared to currently available inulin compositions. It is an object of the invention to provide such improved methods and improved products.

### SUMMARY OF THE INVENTION

The present inventors have surprisingly found that one or more of these objects are achieved by a method for purifying an aqueous liquid comprising inulin, lactucins and sugars, and preferably minerals and organic acids, wherein said inulin comprises a significant amount of low DP inulin and wherein said method comprises filtration of said aqueous liquid by employing a nanofiltration membrane having a molecular weight cut-off value of less than 2 kDa, and without employing ion-exchange treatment.

As will be shown in the appended examples, it was surprisingly found that the selection of an appropriate nanofiltration membrane allows the removal of lactucins and sugars from an aqueous liquid comprising inulin having a significant amount of low DP inulin, lactucins and sugars, while at the same time the nanofiltration preserves low DP inulin. It was further surprisingly found that the selection of this nanofiltration membrane leaves substantial amounts of minerals and organic acids in the retentate that would have been removed from the product with a technique such as ion-exchange treatment. Such an advantageous separation of low DP inulin, minerals and organic acids on the one hand and sugars and lactucins on the other hand could not have been expected based on the molecular sizes of the respective compounds. The method of the present invention may be qualified as environmentally friendly and allows high yields of inulin to be achieved and thus provides a viable industrial-scale method for the purification of aqueous liquids comprising inulin having a significant amount of low DP inulin, lactucins and sugars.

The resulting inulin composition still comprises low DP inulin and substantial amounts of minerals and organic acids, while comprising only low amounts of impurities such as sugar and lactucins. It is minimally processed, has a neutral taste, and qualifies as what is commonly referred to as ‘native’ or ‘raw’ inulin, i.e. it still comprises substantial amounts of all the different DP's which are present in the chicory root.

These unique DP characteristics, combined with substantial amounts of minerals and organic acids and low amounts of lactucins, of the inulin composition in accordance with the invention are also reflected in the corresponding hydrolyzed inulin product, wherein part of the inulin has been enzymatically cleaved to provide an inulin composition comprising large amounts of inulins without a terminal glucose.

### Definitions

As used herein, the term ‘inulin’ refers to polymers composed of linear chains of fructose units connected via a β (2-1) glycosidic bond which may have a terminal glucose unit, wherein the number of monosaccharide units in an inulin molecule (commonly referred to as the degree of polymerization, DP) is at least 3. Inulins with a terminal glucose (alpha-D-glucopyranosyl-[beta-D-fructofuranosyl](n−1)-D-fructofuranosides) are referred to herein as GpyFn inulins. Inulins without a terminal glucose (beta-D-fructopyranosyl-[D-fructofuranosyl](n−1)-D-fructofuranosides) are referred to herein as FpyFn. The wording ‘inulin comprising GpyFn inulins’ as used herein refers to inulin having GpyFn inulin chains with different degree of polymerization. Likewise, the wording ‘inulin comprising FpyFn inulins’ as used herein refers to inulin having FpyFn inulin chains with different degree of polymerization.

As is known to the skilled person, naturally occurring inulin mainly comprises GpyFn, but FpyFn may be present as a product of the hydrolysis of inulins, for example resulting from spontaneous degradation or resulting from a chemical or an enzymatic treatment wherein inulins are hydrolyzed.

A suitable method to determine the inulin chain length distribution is by a chromatographic method, such as high performance anion exclusion chromatography coupled to pulsed amperometric detection (HPAEC-PAD). A preferred method to determine the inulin chain length distribution is in accordance with the HPAEC-PAD protocol described herein. Thus, in embodiments, the methods and products of the invention are provided, having the inulin chain length distribution characteristics as described herein when determined in accordance with the HPAEC-PAD protocol described herein.

As used herein, the term ‘lactucins’ refers to or comprises lactucin, dihydro-lactucin, 8-deoxylactucin-15-oxalate, 8-deoxylactucin and dihydro-8-deoxylactucin. A suitable method to determine the lactucins content, defined as the combined amount (i.e. the sum of) lactucin, dihydro-lactucin, 8-deoxylactucin-15-oxalate, 8-deoxylactucin and dihydro-8-deoxylactucin, is by a chromatographic method, such as ultra-high pressure liquid chromatography coupled to mass spectrometry (UHPLC-MS). A preferred method to determine the lactucins content is in accordance with the UHPLC-MS protocol described herein. Thus, in embodiments, the methods and products of the invention are provided, having the lactucins content characteristics as described herein when determined in accordance with the UHPLC-MS protocol described herein.

As used herein, the term ‘sesquiterpene lactones’ refers to or comprises lactucin, dihydro-lactucin, 8-deoxylactucin-15-oxalate, 8-deoxylactucin, dihydro-8-deoxylactucin, lactucopicrin-15-oxalate, dihydro-lactucopicrin-oxalate, dihydro-lactucopicrin and lactucopicrin. A suitable method to determine the sesquiterpene lactone content, defined as the combined amount (i.e. the sum) of lactucin, dihydro-lactucin, 8-deoxylactucin-15-oxalate, 8-deoxylactucin, dihydro-8-deoxylactucin, lactucopicrin-15-oxalate, dihydro-lactucopicrin-oxalate, dihydro-lactucopicrin and lactucopicrin is by a chromatographic method, such as ultra-high pressure liquid chromatography coupled to mass spectrometry (UHPLC-MS). A preferred method to determine the sesquiterpene lactone content is in accordance with the UHPLC-MS protocol described herein. Thus, in embodiments, the methods and products of the invention are provided, having the sesquiterpene lactone content characteristics as described herein when determined in accordance with the UHPLC-MS protocol described herein.

As used herein, the term ‘sugars’ refers to glucose monosaccharides, fructose monosaccharides, fructose-fructose disaccharides and glucose-fructose disaccharides. Thus, in view of the definitions provided herein, sucrose is included in the term ‘sugars’ and excluded from the term ‘inulin’. A suitable method to determine the sugar content, defined as the combined amount (i.e. the sum) of glucose monosaccharide, fructose monosaccharides, fructose-fructose disaccharides and glucose-fructose disaccharides is by a chromatographic method such as gel permeation chromatography coupled to a refractive index detector (GPC-RI). A preferred method to determine the sugar content is in accordance with the GPC-RI protocol described herein. Thus, in embodiments, the methods and products of the invention are provided, having the sugar content characteristics as described herein when determined in accordance with the GPC-RI protocol described herein.

As used herein, the term ‘nanofiltration’ (sometimes referred to in the art as ultrafiltration) refers to filtration using membranes with a pore size of less than 10 nm.

As used herein, the term ‘microfiltration’ refers to filtration using membranes with a pore size of 0.1-10 μm.

The term ‘chicory’, as used herein, refers to plants of the genus Cichorium, including plants of the species Cichorium endivia, plants of the species Cichorium intybus, varieties thereof, and hybrids thereof. The term “chicory” includes plants of the species Cichorium intybus, including “wild improved” chicories, “Barbe de Capucin” chicories, “sugar loaf” chicories, “Chioggia” chicories, “cicorino” chicories, “Verona” chicories, “Catalonia” chicories, “Treviso” chicories, “Variegato di Castelfranco” chicories, “Witloof” chicories (e.g., “Brussels” chicory or ‘chicon’ chicory), “Soncino” chicories, “red” chicories (e.g., radicchios), “Industrial” chicories (e.g., chicories intended for roasting and for sugars), “fodder” or “game” chicories, and hybrids thereof. The term “chicory” also includes plants of the species Cichorium endivia, including curly endive, also referred to as frisee (var. crispum), escarole, or broad-leaved endive (var. latifolia), and hybrids thereof.

As used herein, the term ‘minerals’ refers to chloride, bromide, nitrate, malate, sulfate, oxalate, phosphate, potassium, sodium, calcium and magnesium. As will be appreciated by those skilled in the art, these are minerals naturally present in the source of the inulin that is present in the aqueous liquid to be purified in the methods as defined herein. Stated differently, these are minerals naturally present in the plant material that is extracted to provide the aqueous liquid to be purified in the methods as defined herein A suitable method to determine the mineral content, defined as the combined amount (i.e. the sum) of chloride, bromide, nitrate, malate, sulfate, oxalate, phosphate, potassium, sodium, calcium and magnesium, is by determining the anion content by chromatography, such as high pressure ion chromatography coupled to a conductivity detector (HPIC-CD) and by determining the cation content by inductively coupled plasma—atomic emission spectroscopy (IPC-AES) analysis. A preferred method to determine the mineral content is in accordance with the HPIC-CD protocol described herein (for the anions) and in accordance with the IPC-AES protocol described herein (for the cations). Thus, in embodiments, the methods and products of the invention are provided, having the mineral content characteristics as described herein when determined in accordance with the HPIC-CD protocol described herein (for the anions) and in accordance with the IPC-AES protocol described herein (for the cations).

As used herein the term ‘organic acids’ refers to citric acid, malic acid, lactic acid, formic acid, acetic acid, propionic acid and butyric acid. As will be appreciated by those skilled in the art, these are organic acids naturally present in the source of the inulin that is present in the aqueous liquid to be purified in the methods as defined herein. Stated differently, these are organic acids naturally present in the plant material that is extracted to provide the aqueous liquid to be purified in the methods as defined herein. A suitable method to determine the organic acid content, defined as the combined amount (i.e. the sum) of citric acid, malic acid, lactic acid, formic acid, acetic acid, propionic acid and butyric acid, is by chromatography, such as high pressure liquid chromatography coupled to a conductivity detector (HPLC-CD). A preferred method to determine the organic acids content is in accordance with the HPLC-CD protocol described herein. Thus, in embodiments the methods and products of the invention are provided, having the organic acids content characteristics as described herein when determined in accordance with the HPLC-conductivity protocol described herein.

As used herein the term ‘polyphenols’ refers to 4-O-caffeoylquinate, chlorogenic acid, caffeic acid and cichoric acid. A suitable method to determine the polyphenols content, defined as the combined amount (i.e. the sum) of 4-O-caffeoylquinate, chlorogenic acid, caffeic acid and cichoric acid is by liquid chromatography coupled to UV and subsequent mass spectrometry detection (LC-MS). A preferred method to determine the polyphenols content is in accordance with the LC-MS protocol described herein. Thus, in embodiments, the methods and products of the invention are provided, having the polyphenols content characteristics as described herein when determined in accordance with the LC-MS protocol described herein.

As used herein, the term ‘ion-exchange treatment’ comprises cation exchange using an ion-exchange resin, anion exchange using an ion-exchange resin as well as ion-exchange chromatography.

### DETAILED DESCRIPTION

According to an aspect of the present invention, there is provided a method for purifying an aqueous liquid comprising inulin, said method comprising the steps of:
a) providing an aqueous liquid comprising inulin and one or both of the following components:
   lactucins in an amount of more than 0.01 wt. % (by weight of inulin), preferably more than 0.1 wt. %, more preferably more than 0.3 wt. %; and
   sugars in an amount of more than 3 wt. % (by weight of inulin), preferably more than 4 wt. %, more preferably more than 5 wt. %;
b) subjecting the aqueous liquid of step a) to a nanofiltration step employing a nanofiltration membrane having a molecular weight cut-off value of less than 2 kDa, preferably less than 1.5 kDa, more preferably less than 1.2 kDa, more preferably less than 1.05 kDa; and
c) collecting the retentate;
   wherein more than 5 wt. % (by weight of inulin), preferably more than 8 wt. %, more preferably more than 12 wt. % of the inulin comprised in the aqueous liquid provided in step a) has a DP within the range of 3-5.

### Aqueous Liquid Comprising Inulin

In embodiments, the chain length distribution of the GpyFn inulins comprised in the aqueous liquid provided in step a) has one, two, three, four, five or all of the following characteristics:
15-40%, preferably 20-35% of the GpyFn has a DP within the range of 3-10;
15-30%, preferably 18-28% of the GpyFn has a DP within the range of 11-15;
10-25%, preferably 10-20% of the GpyFn has a DP within the range of 16-20;
5-20%, preferably 7-15% of the GpyFn has a DP within the range of 21-25;
3-15%, preferably 5-10% of the GpyFn has a DP within the range of 26-30;
2-12%, preferably 3-8% of the GpyFn has a DP within the range of 31-35;
1-10%, preferably 2-6% of the GpyFn has a DP within the range of 36-40;
0.5-8%, preferably 0.5-4% of the GpyFn has a DP within the range of 41-45;
0.5-10%, preferably 1-6% of the GpyFn has a DP within the range of 46-64;
0.1-4%, preferably 0.2-3% of the GpyFn has a DP of more than 64.

In preferred embodiments, the chain length distribution of the GpyFn inulins comprised in the aqueous liquid provided in step a) has all of the following characteristics:
more than 10%, preferably more than 20% of the GpyFn inulins have a DP within the range of 3-10;
more than 10%, preferably more than 20% of the GpyFn inulins have a DP of more than 15.

In embodiments, the GpyFn inulins comprised in the aqueous liquid provided in step a) have a chain length distribution wherein every DP within the range of 3-60, preferably within the range of 3-40, preferably within the range of 3-30 is present in an amount of at least 0.1%, preferably at least 1%.

As will be appreciated by those skilled in the art, the source of the inulin in the aqueous liquid provided in step a) is plant material comprising sesquiterpene lactones, such as lactucins. In preferred embodiments, the inulin provided in step a) of the methods and products provided herein is chicory inulin. Other sources of inulin that are encompassed by the invention include Globe Artichoke, amongst others.

In highly preferred embodiments, the source of the inulin in the aqueous liquid provided in step a) of the methods and the products provided herein is Cichorium intybus inulin. In an even more preferred embodiment, the source of the inulin in the aqueous liquid provided in step a) of the methods and products provided herein is Cichorium intybus L. var. sativum, such as Cichorium intybus L. var. sativum DC.

In embodiments, the aqueous liquid provided in step a) comprises more than 3 wt. % (by weight of inulin), preferably more than 4 wt. % of minerals.

In embodiments the aqueous liquid provided in step a) comprises more than 3 wt. % (by weight of inulin), preferably more than 4 wt. % of organic acids, wherein the organic acids are preferably chosen from the group consisting of citric acid, malic acid, lactic acid, formic acid, acetic acid, propionic acid, butyric acid and combinations thereof.

In preferred embodiments, the aqueous liquid provided in step a) has not been subjected to ion-exchange treatment and/or active carbon filtration.

In preferred embodiments, the aqueous liquid provided in step a) has not been subjected to ion-exchange treatment and active carbon filtration.

In preferred embodiments, the method for purifying the aqueous liquid comprising inulin in accordance with the invention does not comprise ion-exchange treatment and/or active carbon filtration. In preferred embodiments the method for purifying an aqueous liquid comprising inulin in accordance with the invention does not comprise ion-exchange treatment and active carbon filtration.

In a very preferred embodiment, the method as defined herein does not comprise ion-exchange treatment.

In an embodiment, the method as defined herein does not comprise an ion-exchange treatment and does comprise an active carbon treatment of the retentate obtained in step (c).

In a very preferred embodiment, the method as defined herein does not comprise a crystallization step.

In a very preferred embodiment, the method for purifying the aqueous liquid comprising inulin comprises the steps of:
a) providing an aqueous liquid comprising:
   inulin, wherein more than 5 wt. % (by weight of inulin), preferably more than 8 wt. %, more preferably more than 12 wt. % of the inulin has a DP within the range of 3-5, said inulin comprising GpyFn inulins with a terminal glucose, wherein the GpyFn inulins have a chain length distribution wherein every DP within the range of 3-60 is present in an amount of at least 0.1%, preferably at least 1%;
   lactucins in an amount of more than 0.1 wt. % (by weight of inulin), more preferably more than 0.3 wt. %;
   sugars in an amount of more than 3 wt. % (by weight of inulin), preferably more than 4 wt. %, more preferably more than 5 wt. %;
   more than 3 wt. % (by weight of inulin), preferably more than 4 wt. % of minerals; and
   more than 3 wt. % (by weight of inulin), preferably more than 4 wt. % of organic acids, wherein the organic acids are preferably chosen from the group consisting of citric acid, malic acid, lactic acid, formic acid, acetic acid, propionic acid, butyric acid and combinations thereof;
b) subjecting the aqueous liquid of step a) to a nanofiltration step employing a nanofiltration membrane having a molecular weight cut-off value of less than 2 kDa, preferably less than 1.5 kDa, more preferably less than 1.2 kDa, more preferably less than 1.05 kDa; and
c) collecting the retentate of nanofiltration step b) comprising:
   inulin, wherein more than 2% (by weight of inulin), preferably more than 4%, more preferably more than 6% of the inulin has a DP within the range of 3-5, said inulin comprising GpyFn inulins with a terminal glucose, wherein the GpyFn inulins have a chain length distribution wherein every DP within the range of 3-60 is present in an amount of at least 0.1%, preferably at least 1%;
   less than 0.1 wt. % (by weight of inulin), preferably less than 0.05 wt. %, more preferably less than 0.01 wt. % of lactucins;
   less than 3 wt. % (by weight of inulin), preferably less than 2 wt. %, more preferably less than 1.5 wt. % of sugars;
   less than 20 wt. % (by weight of inulin), preferably less than 10 wt. % (by weight of inulin), more preferably less than 5 wt. %, even more preferably less than 2 wt. % of FpyFn;
   more than 0.1 wt. % (by weight of inulin), preferably more than 0.8 wt. % of minerals; and
   more than 0.1 wt. % (by weight of inulin), preferably more than 0.8 wt. % of organic acids, wherein the organic acids are preferably chosen from the group consisting of citric acid, malic acid, lactic acid, formic acid, acetic acid, propionic acid, butyric acid and combinations thereof,
      wherein the method does not comprise an ion-exchange treatment.

In highly preferred embodiments, less than 20 wt. % (by weight of inulin), preferably less than 10 wt. %, more preferably less than 5 wt. % of the inulin comprised in the aqueous liquid provided in step a) is FpyFn.

In embodiments, the inulin comprised in the aqueous liquid provided in step a) has a number-average degree of polymerization (DP) in the range of 3-60, preferably within the range of 5-30, preferably within the range of 8-13.

In embodiments, the method for purifying an aqueous liquid comprising inulin in accordance with the invention does not comprise a nanofiltration step before the nanofiltration of step b).

In embodiments, the method for purifying the aqueous liquid comprising inulin in accordance with the invention is provided wherein the aqueous liquid provided in step a) comprises less than 1 vol %, preferably less than 0.1 vol % of other solvents than water, such as alcohols. In embodiments the aqueous liquid provided in step a) is substantially free of other solvents than water, such as alcohols.

In preferred embodiments, the aqueous liquid provided in step a) and the inulin comprised therein have not been subjected to a hydrolysis treatment, such as an enzymatic hydrolysis treatment.

In embodiments, the aqueous liquid provided in step a) comprises more than 1 wt. % (by weight of aqueous liquid), preferably more than 5 wt. %, more preferably more than 10 wt. % of inulin.

In embodiments, the aqueous liquid provided in step a) comprises 1-30 wt. %, preferably 5-20 wt. %, more preferably 5-15 wt. % of inulin. A suitable method to determine the inulin content is by a chromatographic method, such as gel permeation chromatography coupled to a refractive index detector (GPC-RI). A preferred method to determine the inulin content is in accordance with the GPC-RI protocol described herein. Thus, in embodiments, the methods and products of the invention are provided, having the inulin content characteristics as described herein when determined in accordance with the GPC-RI protocol described herein.

In embodiments, the aqueous liquid provided in step a) has a dry-matter content of more than 5% (w/v), more preferably more than 10% (w/v).

In embodiments, the aqueous liquid provided in step a) comprises more than 0.4 wt. % (by weight of inulin), preferably more than 0.6 wt. %, more preferably more than 0.8 wt. % of sesquiterpene lactones.

In embodiments, more than 10 wt. % (by weight of the sesquiterpene lactones), preferably more than 20 wt. % of the sesquiterpene lactones comprised in the aqueous liquid provided in step a) are lactucins.

In embodiments, the aqueous liquid provided in step a) comprises more than 6 wt. % (by weight of inulin), preferably more than 7 wt. %, more preferably more than 8 wt. % of sugars.

In embodiments the aqueous liquid provided in step a) comprises more than 0.05 wt. % (by weight of inulin), preferably more than 0.1 wt. % of polyphenols.

In embodiments, step a) comprises the following steps:
a1) providing a plant material comprising inulin, proteins, sugars and lactucins, preferably chicory root;
a2) subjecting the plant material to a processing step to provide an aqueous liquid comprising inulin, sugars, proteins, lactucins and processed plant material;
a3) separating the processed plant material and the aqueous liquid; and
a4) subjecting the aqueous liquid to a protein removal step wherein the proteins are at least partially removed to provide the aqueous liquid of step a).

Step a2) may be performed in many ways in order to provide an aqueous liquid comprising inulin, sugars, proteins and lactucins. In accordance with the invention, step a2) preferably comprises a processing step selected from the group consisting of thermal aqueous extraction, pulsed electric field treatment, increased pressure treatment, reduced pressure treatment, fermentation, acidification, freezing, size reduction, enzyme-assisted extraction, ultrasound treatment, microwave treatment, supercritical fluid extraction and combinations thereof. In very preferred embodiments, step a2) comprises a processing step selected from the group consisting of thermal aqueous extraction and/or pulsed electric field treatment.

In embodiments, step a2) comprises mashing the plant material, such as chicory roots, in order to make the aqueous liquid comprised in the plant material available for separation/collection.

In highly preferred embodiments, step a2) comprises contacting the plant material with an aqueous extraction liquid for an amount of time sufficient to at least partially extract the inulin. Thus, in preferred embodiments step a) comprises the following steps:
a1) providing a plant material comprising inulin, proteins, sugars and lactucins, preferably chicory root;
a2) contacting the plant material with an aqueous extraction liquid for an amount of time sufficient to provide an aqueous extraction liquid comprising inulin, sugars, proteins, lactucins, and processed plant material;
a3) separating the processed plant material and the aqueous extraction liquid; and
a4) submitting the aqueous extraction liquid to a protein removal step wherein the proteins are at least partially removed to provide the aqueous liquid of step a).

The extraction of step a2) may be performed on chopped, grinded, sliced or unsliced inulin-containing plant material, such as sliced chicory roots. In embodiments, the extraction of step a2) is performed on inulin-containing plant material slices with an average product thickness of 0.5-10 mm, preferably 1-5 mm. The inulin-containing plant material may have been chopped, grinded or sliced by any suitable means known to the person skilled in the art, such as a drum slicer, a disc slicer, chopper or cutter. In preferred embodiments, the extraction step a2) is performed at a temperature within the range of 55-90° C., preferably 65-75° C. In preferred embodiments, the extraction step a2) is a counter-current extraction step. In embodiments, the aqueous extraction liquid comprises an alcohol, such as ethanol. Thus, in embodiments the aqueous liquid provided in step a) comprises an alcohol, such as ethanol.

Step a3) may be performed by any means known to the skilled person, such as pressing, decantation and/or filtration. For example, step a3) may be performed using a screw press or basket press equipped with a screen with suitable pore size, such as 0.1-10 mm, preferably 0.5-5 mm, preferably 1-2 mm.

Step a4), sometimes referred to in the art as a clarification step, may be performed by any means known to the skilled person, such as liming, carbonation, centrifugation, filtration and/or filtration with the aid of diatomaceous earth or siliceous earths. In preferred embodiments, step a4) comprises or consists of centrifugation and/or microfiltration. In highly preferred embodiments, step a4) comprises or consists of microfiltration.

In preferred embodiments, step a4) comprises lowering the protein content such that the aqueous liquid of step a) comprises less than 5 wt. % (by total weight of the inulin) protein, preferably less than 3 wt. %, more preferably less than 1 wt. % protein, wherein the protein content is determined using the Kjehldahl method with a conversion factor of 6.25.

As will be understood by the skilled person, the nanofiltration of step b) may be preceded at any point in the method of the invention by a coarse physical purification step to remove large particles such as filtration. Thus, in preferred embodiments, step a) further comprises a coarse physical purification step. In embodiments the coarse physical purification step comprises filtration using a screen with aperture larger than 50 μm, preferably larger than 90 μm, preferably larger than 100 μm.

### Nanofiltration Step

The nanofiltration membrane employed in step b) of the method in accordance with the invention may be provided in any form known to the person skilled in the art, preferably in the form of a flat sheet, hollow-fiber, tubular or spiral wound membrane.

In preferred embodiments, the nanofiltration membrane employed in step b) has a molecular weight cut-off value of more than 0.3 kDa, preferably more than 0.4 kDa, more preferably more than 0.5 kDa.

In embodiments, the nanofiltration membrane employed in step b) has a molecular weight cut-off value of more than 0.5 kDa, more than 0.6 kDa, more than 0.7 kDa, more than 0.8 kDa, or more than 0.9 kDa.

In embodiments, the nanofiltration membrane employed in step b) has a molecular weight cut-off value of less than 1.9 kDa, less than 1.8 kDa, less than 1.7 kDa, less than 1.6 kDa, less than 1.5 kDa, less than 1.4 kDa, less than 1.3 kDa, less than 1.2 kDa or less than 1.1 kDa.

In highly preferred embodiments, the nanofiltration membrane employed in step b) has a molecular weight cut-off value of about 1 kDa, preferably of 1 kDa.

In embodiments, the nanofiltration membrane employed in step b) has a molecular weight cut-off value within the range of 0.5-1.5 kDa, preferably within the range of 0.8-1.2 kDa, more preferably within the range of 0.95-1.05 kDa.

In embodiments, the nanofiltration membrane employed in step b) has a molecular weight cut-off value within the range of 0.5-1.2 kDa, preferably within the range of 0.6-0.8 kDa.

In embodiments, the nanofiltration membrane employed in nanofiltration step b) comprises or consists of one or more polymers selected from the group consisting of polyamide (PA), polysulfone (PS), polyethersulfone (PES), polyimide and polypiperazine, preferably polyamide (PA) or polypiperazine.

In a very preferred embodiment, the nanofiltration membrane has a narrow pore size distribution, such as a pore size distribution having pores with diameters D characterized by a span=(D₉₀−D₁₀)/D₅₀ of below 0.1, preferably below 0.05.

In embodiments, the nanofiltration membrane employed in step b) is a ceramic membrane.

In embodiments, the nanofiltration membrane employed in step b) comprises or consists of a thin-film composite membrane, preferably a thin-film composite membrane comprising polyamide or polypiperazine.

In embodiments, the nanofiltration membrane employed in step b) is capable of achieving a membrane selectivity S of more than 5, preferably more than 8, preferably more than 12.

As used herein the membrane selectivity S is defined as follows:

$$S = \frac{{C}_{Ir}}{{C}_{SLr}} / \frac{{C}_{Ip}}{{C}_{SLp}}$$

wherein
S is the membrane selectivity;
Cₗᵣ is the inulin concentration in the retentate stream (wt. % based on the weight of the retentate);
C_{SLr} is the sesquiterpene lactones concentration in the retentate stream (wt. % based on the weight of the retentate);
Cₗₚ is the inulin concentration in the permeate stream (wt. % based on the weight of the permeate); and
C_{SLp} is the sesquiterpene lactones concentration in the permeate stream (wt. % based on the weight of the permeate).

In embodiments, the nanofiltration membrane is capable of achieving the membrane selectivity S as defined herein at a temperature within the range of 10-70° C., preferably 40-60° C., a flux within the range of 10-60 l/(m²*hour), preferably 20-40 l/(m²*hour) and a transmembrane pressure within the range of 5-40 bar, preferably 10-25 bar.

In embodiments, step b) is performed such that the transmembrane pressure is more than 2 bar, for example in the range of 5-30 bar. In preferred embodiments step b) is performed such that the transmembrane pressure is more than 6 bar, more than 10 bar, more than 20 bar, or more than 40 bar.

In preferred embodiments, the nanofiltration in step b) is performed as a diafiltration. As is known to the skilled person, a nanofiltration step results in a feed stream being separated into a retentate stream and a permeate stream. Diafiltration is an operating mode of nanofiltration wherein the retentate stream is recirculated and added to the feed stream, and solvent, preferably demineralized water, is added to the feed stream to compensate for the permeate losses. Addition of a volume of solvent, preferably demineralized water, equal to the volume of feed is referred to as 1 washing volume, indicated as W/F=1. In preferred embodiments, the nanofiltration in step b) is performed as a diafiltration using demineralized water, wherein W/F is in the range of 1-8, preferably, W/F is in the range of 2-6, more preferably W/F is in the range of 4.5-5.5. In preferred embodiments, the nanofiltration in step b) is performed as a diafiltration using demineralized water, wherein W/F is in the range of 1-7, preferably, W/F is in the range of 1-4, more preferably W/F is in the range of 1.5-3.5.

In preferred embodiments, the nanofiltration in step b) is performed at a feed temperature within the range of 20-80° C., preferably within the range of 30-70° C., more preferably within the range of 35-55° C., most preferably within the range of 40-50° C.

In embodiments, the nanofiltration in step b) is performed at a feed temperature of more than 50° C., preferably of more than 60° C., more preferably of more than 70° C.

In embodiments, the nanofiltration in step b) employs measures to prevent fouling of the membrane, such as cross-flow filtration, mechanical agitation, increasing the shear or turbulence of the feed at the membrane surface.

The present inventors have found that the methods in accordance with the invention advantageously allow the retention of low amounts of polyphenols, and substantial amounts of organic acids or nutrients in the form of minerals as defined herein. As will be shown in the appended examples, the amount of polyphenols, organic acids and/or nutrients retained is low enough to provide a product with desirable organoleptic and/or colour properties, while the amount may be sufficient to impart one or more beneficial effects to the composition. For example, low amounts of polyphenols may have an anti-inflammatory and/or anticarcinogenic effect; low amounts of organic acids may have a preservative effect; and low amounts of minerals may serve as (micro)nutrients.

### Retentate

In embodiments, the retentate collected in step c) comprises more than 1 wt. % (by weight of retentate), preferably more than 5 wt. % of inulin. In embodiments, the retentate collected in step c) comprises 1-20 wt. % (by weight of retentate), preferably 2-15 wt. %, more preferably 4-8 wt. % of inulin.

In embodiments, the retentate collected in step c) has a dry-matter content of more than 5% (w/v), more preferably more than 8% (w/v).

In embodiments, more than 2 wt. % (by weight of inulin), preferably more than 4 wt. %, more preferably more than 6 wt. % of the inulin comprised in the retentate collected in step c) has a DP within the range of 3-5.

In highly preferred embodiments, less than 20 wt. % (by weight of inulin), preferably less than 10 wt. %, more preferably less than 5 wt. %, even more preferably less than 2 wt. % of the inulin comprised in the retentate collected in step c) is FpyFn.

In embodiments, the inulin comprised in the retentate collected in step c) has a number-average degree of polymerization in the range of 3-60, preferably within the range of 5-30, preferably within the range of 8-13.

In embodiments the chain length distribution of the GpyFn comprised in the retentate collected in step c) has one, two, three, four, five or all of the following characteristics:
15-40%, preferably 20-35% of the GpyFn has a DP within the range of 3-10;
15-30%, preferably 18-28% of the GpyFn has a DP within the range of 11-15;
10-25%, preferably 10-20% of the GpyFn has a DP within the range of 16-20;
5-20%, preferably 7-15% of the GpyFn has a DP within the range of 21-25;
3-15%, preferably 5-10% of the GpyFn has a DP within the range of 26-30;
2-12%, preferably 3-8% of the GpyFn has a DP within the range of 31-35;
1-10%, preferably 2-6% of the GpyFn has a DP within the range of 36-40;
0.5-8%, preferably 0.5-4% of the GpyFn has a DP within the range of 41-45;
0.5-10%, preferably 1-6% of the GpyFn has a DP within the range of 46-64;
0.1-4%, preferably 0.2-3% of the GpyFn has a DP of more than 64.

In preferred embodiments, the chain length distribution of the GpyFn comprised in the retentate collected in step c) has all of the following characteristics:
more than 10%, preferably more than 20% of the GpyFn has a DP within the range of 3-10;
more than 10%, preferably more than 20% of the GpyFn has a DP of more than 15.

In preferred embodiments, the chain length distribution of the GpyFn comprised in the retentate collected in step c) has all of the following characteristics:
more than 0.3%, preferably more than 0.5%, more preferably more than 1% of the GpyFn has a DP of 3;
more than 0.5%, preferably more than 1%, more preferably more than 2% of the GpyFn has a DP of 4;
more than 0.7%, preferably more than 1.7%, more preferably more than 2.5% of the GpyFn has a DP of 5.

In embodiments, the GpyFn comprised in the retentate collected in step c) has a chain length distribution wherein every DP within the range of 3-60, preferably within the range of 3-40, preferably within the range of 3-30 is present in an amount of at least 0.1%, preferably at least 1%.

In embodiments, the retentate collected in step c) comprises less than 0.4 wt. % (by weight of inulin), preferably less than 0.2 wt. %, more preferably less than 0.1 wt. % of sesquiterpene lactones.

In embodiments, the retentate collected in step c) comprises less than 0.1 wt. % (by weight of inulin), preferably less than 0.05 wt. %, more preferably less than 0.01 wt. % of lactucins.

In embodiments less than 10 wt. % (by weight of the sesquiterpene lactones), preferably less than 5 wt. % of the sesquiterpene lactones comprised in the retentate collected in step c) are lactucins.

In embodiments, the retentate collected in step c) comprises less than 3 wt. % (by weight of inulin), preferably less than 2 wt. %, more preferably less than 1.5 wt. % of sugars. In embodiments, the retentate collected in step c) comprises less than 1 wt. % (by weight of inulin), preferably less than 0.5 wt. %, more preferably less than 0.2 wt. % of sugars.

In embodiments, the retentate collected in step c) comprises less than 3 wt. % (by weight of inulin), preferably less than 1.5 wt. % of minerals. In embodiments, the retentate collected in step c) comprises more than 0.1 wt. % (by weight of inulin), preferably more than 0.8 wt. % of minerals.

In embodiments, the retentate collected in step c) comprises less than 2.5 wt. % (by weight of inulin), preferably less than 1.5 wt. % of organic acids, wherein the organic acids are preferably chosen from the group consisting of citric acid, malic acid, lactic acid, formic acid, acetic acid, propionic acid, butyric acid and combinations thereof. In embodiments, the retentate collected in step c) comprises more than 0.1 wt. % (by weight of inulin), preferably more than 0.8 wt. % of organic acids, wherein the organic acids are preferably chosen from the group consisting of citric acid, malic acid, lactic acid, formic acid, acetic acid, propionic acid, butyric acid and combinations thereof.

In embodiments, the retentate collected in step c) comprises less than 0.05 wt. % (by weight of inulin), preferably less than 0.03 wt. % of polyphenols. In embodiments the retentate collected in step c) comprises more than 0.005 wt. % (by weight of inulin), preferably more than 0.01 wt. % of polyphenols.

In highly preferred embodiments, step c) further comprises collecting the permeate.

In preferred embodiments, the method for purifying the aqueous liquid comprising inulin in accordance with the invention is performed such that the total amount of inulin comprised in the retentate collected in step c) is more than 80 wt. %, preferably more than 90 wt. %, more preferably more than 95 wt. %, most preferably more than 98 wt. % of the total amount of inulin present in the aqueous liquid provided in step a).

In embodiments, there is provided the method for purifying the aqueous liquid comprising inulin as described herein, wherein the nanofiltration in step b) is performed such that the ratio of the amount of sugars in the aqueous liquid provided in step a) to the amount of sugars in the retentate collected in step c) is more than 5, more preferably more than 8.

In embodiments, the nanofiltration in step b) is performed such that the ratio of the amount of DP3-DP5 inulin in the aqueous liquid provided in step a) to the amount of DP3-DP5 inulin in the retentate collected in step c) is less than 4, more preferably less than 3.

In embodiments, the nanofiltration in step b) is performed such that the ratio of the amount of sesquiterpene lactones in the aqueous liquid provided in step a) to the amount of sesquiterpene lactones in the retentate collected in step c) is more than 4, more preferably more than 5.

In embodiments, the nanofiltration in step b) is performed such that the ratio of the amount of lactucins in the aqueous liquid provided in step a) to the amount of lactucins in the retentate collected in step c) is more than 6, more preferably more than 8.

In embodiments, the nanofiltration in step b) is performed such that the ratio of the amount of minerals in the aqueous liquid provided in step a) to the amount of minerals in the retentate collected in step c) is in the range of 2-10, more preferably in the range of 3-7. In embodiments, the nanofiltration in step b) is performed such that the ratio of the amount of minerals in the aqueous liquid provided in step a) to the amount of minerals in the retentate collected in step c) is more than 4, more preferably in more than 5.

In embodiments, the nanofiltration in step b) is performed such that the ratio of the amount of organic acids in the aqueous liquid provided in step a) to the amount of organic acids in the retentate collected in step c) is in the range of 2-10, more preferably in the range of 2-6. In embodiments, the nanofiltration in step b) is performed such that the ratio of the amount of organic acids in the aqueous liquid provided in step a) to the amount of organic acids in the retentate collected in step c) is more than 3, more preferably more than 4.

In embodiments, the nanofiltration in step b) is performed such that the ratio of the amount of polyphenols in the aqueous liquid provided in step a) to the amount of polyphenols in the retentate collected in step c) is in the range of 2-10, more preferably in the range of 3-7. In embodiments, the nanofiltration in step b) is performed such that the ratio of the amount of polyphenols in the aqueous liquid provided in step a) to the amount of polyphenols in the retentate collected in step c) is more than 5, more preferably more than 6.5.

### Concentrating the Retentate

In embodiments, the method of the present invention as described herein further comprises a step d) of concentrating the retentate to provide an inulin concentrate with an inulin concentration of at least 20 wt. %, preferably at least 60 wt. %.

In embodiments, step d) comprises concentrating the retentate to provide an inulin concentrate with a dry matter content of at least 50% (w/v), preferably at least 70 wt. % (w/v).

Concentrating the retentate may be performed by any process or combination of processes known in the art, such as evaporation, precipitation, spray-drying, freeze-drying or drum drying. In highly preferred embodiments, step d) comprises or consists of evaporation and/or spray-drying, preferably evaporation followed by spray-drying.

In highly preferred embodiments, the retentate is concentrated such that the relative concentration of the different components in the resulting inulin composition are substantially the same as for the retentate described herein earlier.

Thus, in embodiments, more than 2 wt. % (by weight of inulin), preferably more than 4 wt. %, more preferably more than 6 wt. % of the inulin comprised in the inulin concentrate of step d) has a DP within the range of 3-5.

In highly preferred embodiments, less than 20 wt. % (by weight of inulin), preferably less than 10 wt. %, more preferably less than 5 wt. %, even more preferably less than 2 wt. % of the inulin comprised in the inulin concentrate of step d) is FpyFn.

In embodiments, the inulin comprised in the inulin concentrate of step d) has a number-average degree of polymerization in the range of 3-60, preferably within the range of 5-30, preferably within the range of 8-13.

In embodiments, the chain length distribution of the GpyFn comprised in the inulin concentrate of step d) has one, two, three, four, five or all of the following characteristics:
15-40%, preferably 20-35% of the GpyFn has a DP within the range of 3-10;
15-30%, preferably 18-28% of the GpyFn has a DP within the range of 11-15;
10-25%, preferably 10-20% of the GpyFn has a DP within the range of 16-20;
5-20%, preferably 7-15% of the GpyFn has a DP within the range of 21-25;
3-15%, preferably 5-10% of the GpyFn has a DP within the range of 26-30;
2-12%, preferably 3-8% of the GpyFn has a DP within the range of 31-35;
1-10%, preferably 2-6% of the GpyFn has a DP within the range of 36-40;
0.5-8%, preferably 0.5-4% of the GpyFn has a DP within the range of 41-45;
0.5-10%, preferably 1-6% of the GpyFn has a DP within the range of 46-64;
0.1-4%, preferably 0.2-3% of the GpyFn has a DP of more than 64.

In preferred embodiments, the chain length distribution of the GpyFn comprised in the inulin concentrate of step d) has all of the following characteristics:
more than 10%, preferably more than 20% of the GpyFn has a DP within the range of 3-10;
more than 10%, preferably more than 20% of the GpyFn has a DP of more than 15.

In preferred embodiments, the chain length distribution of the GpyFn in the inulin concentrate of step d) has all of the following characteristics:
more than 0.3%, preferably more than 0.5%, more preferably more than 1% of the GpyFn has a DP of 3;
more than 0.5%, preferably more than 1%, more preferably more than 2% of the GpyFn has a DP of 4;
more than 0.7%, preferably more than 1.7%, more preferably more than 2.5% of the GpyFn has a DP of 5.

In embodiments, the GpyFn comprised in the inulin concentrate of step d) has a chain length distribution wherein every DP within the range of 3-60, preferably within the range of 3-40, preferably within the range of 3-30 is present in an amount of at least 0.1%, preferably at least 1%.

In a very preferred embodiment, the inulin concentrate of step d) comprises:
inulin, wherein more than 2%, preferably more than 4%, more preferably more than 6% of the inulin has a DP within the range of 3-5, said inulin comprising GpyFn inulins with a terminal glucose, wherein the GpyFn has a chain length distribution wherein every DP within the range of 3-60 is present in an amount of at least 0.1%, preferably at least 1%;
less than 0.1 wt. % (by weight of inulin), preferably less than 0.05 wt. %, more preferably less than 0.01 wt. % of lactucins;
less than 3 wt. % (by weight of inulin), preferably less than 2 wt. %, more preferably less than 1.5 wt. % of sugars;
less than 20 wt. % (by weight of inulin), preferably less than 10 wt. %, more preferably less than 5 wt. %, even more preferably less than 2 wt. % of FpyFn;
more than 0.1 wt. % (by weight of inulin), preferably more than 0.8 wt. % of minerals; and
more than 0.1 wt. % (by weight of inulin), preferably more than 0.8 wt. % of organic acids, wherein the organic acids are preferably chosen from the group consisting of citric acid, malic acid, lactic acid, formic acid, acetic acid, propionic acid, butyric acid and combinations thereof.

In embodiments, the inulin concentrate of step d) comprises less than 1 wt. % (by weight of inulin), preferably less than 0.2 wt. %, more preferably less than 0.1 wt. % of sesquiterpene lactones.

In embodiments, the inulin concentrate of step d) comprises less than 0.1 wt. % (by weight of inulin), preferably less than 0.05 wt. %, more preferably less than 0.01 wt. % of lactucins.

In embodiments, less than 10 wt. % (by weight of the sesquiterpene lactones), preferably less than 5 wt. % of the sesquiterpene lactones comprised in the inulin concentrate of step d) are lactucins.

In embodiments, the inulin concentrate of step d) comprises less than 3 wt. % (by weight of inulin), preferably less than 2 wt. %, more preferably less than 1.5 wt. % of sugars. In embodiments, the inulin concentrate of step d) comprises less than 1 wt. % (by weight of inulin), preferably less than 0.5 wt. %, more preferably less than 0.2 wt. % of sugars.

In embodiments, the inulin concentrate of step d) comprises less than 3 wt. % (by weight of inulin), preferably less than 1.5 wt. % of minerals. In embodiments, the inulin concentrate of step d) comprises more than 0.1 wt. % (by weight of inulin), preferably more than 0.8 wt. % of minerals.

In embodiments, the inulin concentrate of step d) comprises less than 2.5 wt. % (by weight of inulin), preferably less than 1.5 wt. % of organic acids, wherein the organic acids are preferably chosen from the group consisting of citric acid, malic acid, lactic acid, formic acid, acetic acid, propionic acid, butyric acid and combinations thereof. In embodiments, the inulin concentrate of step d) comprises more than 0.1 wt. % (by weight of inulin), preferably more than 0.8 wt. % of organic acids, wherein the organic acids are preferably chosen from the group consisting of citric acid, malic acid, lactic acid, formic acid, acetic acid, propionic acid, butyric acid and combinations thereof.

In embodiments, the inulin concentrate of step d) comprises less than 0.05 wt. % (by weight of inulin), preferably less than 0.03 wt. % of polyphenols. In embodiments, the inulin concentrate of step d) comprises more than 0.005 wt. % (by weight of inulin), preferably more than 0.01 wt. % of polyphenols.

In embodiments, the inulin concentrate of step d) is in the form of an aqueous solution comprising 20-80 wt. %, preferably 30-60 wt. % inulin and which has a dry matter content of less than 85% (w/v), preferably less than 65% (w/v).

In embodiments, the inulin concentrate of step d) is in the form of a powder, preferably a spray-dried powder, comprising more than 80 wt. %, preferably more than 85 wt. %, more preferably more than 90 wt. %, most preferably more than 95 wt. % inulin and which has a dry matter content of more than 80% (w/v), preferably more than 85% (w/v), more preferably more than 90% (w/v), most preferably more than 95% (w/v).

In embodiments, the retentate collected in step c) and/or the concentrate of step d) or the inulin comprised therein has not been subjected to an enzymatic hydrolysis treatment.

### Inulin Compositions

In another aspect, the invention provides the inulin compositions, such as the retentate and the inulin concentrate obtained by or obtainable by the method for purifying the aqueous liquid comprising inulin as described herein.

As explained earlier, the process in accordance with the invention has for the first time made available an inulin composition which is rich in both high and low DP inulin, like in the plant material, such as in chicory, has a low sesquiterpene lactone or lactucins content, a low sugar content, and still a substantial content of the nutritionally valuable minerals and organic acids that are naturally present in the plant material, such as in chicory.

Thus, in another aspect the invention provides an inulin composition which comprises:
less than 0.1 wt. % (by weight of inulin), preferably less than 0.05 wt. %, more preferably less than 0.01 wt. % of lactucins;
less than 3 wt. % (by weight of inulin), preferably less than 2 wt. %, more preferably less than 1.5 wt. % of sugars;
less than 20 wt. % (by weight of inulin), preferably less than 10 wt. %, more preferably less than 5 wt. %, even more preferably less than 2 wt. % of FpyFn;
   and wherein
more than 2%, preferably more than 4%, more preferably more than 6% of the inulin has a DP within the range of 3-5; and
more than 10%, preferably more than 20% of the inulin has a DP of more than 15.

In embodiments, the inulin composition comprises more than 1 wt. % (by total weight of the inulin composition), preferably more than 5 wt. %, more preferably more than 10 wt. % of inulin.

In embodiments, the inulin composition is in the form of an aqueous solution comprising 20-80 wt. % (by total weight of the inulin composition), preferably 30-60 wt. % inulin and which has a dry matter content of less than 85% (w/v), preferably less than 65% (w/v).

In embodiments, the inulin composition is in the form of a powder, preferably a spray-dried powder, comprising more than 80 wt. %, preferably more than 85%, more preferably more than 90%, most preferably more than 95% inulin and which has a dry matter content of more than 80% (w/v), preferably more than 85% (w/v), more preferably more than 90% (w/v), most preferably more than 95% (w/v).

In embodiments, the inulin comprised in the inulin composition has a number-average degree of polymerization in the range of 3-60, preferably within the range of 5-30, preferably within the range of 8-13.

In embodiments, the chain length distribution of the GpyFn comprised in the inulin composition has one, two, three, four, five or all of the following characteristics:
15-40%, preferably 20-35% of the GpyFn has a DP within the range of 3-10;
15-30%, preferably 18-28% of the GpyFn has a DP within the range of 11-15;
10-25%, preferably 10-20% of the GpyFn has a DP within the range of 16-20;
5-20%, preferably 7-15% of the GpyFn has a DP within the range of 21-25;
3-15%, preferably 5-10% of the GpyFn has a DP within the range of 26-30;
2-12%, preferably 3-8% of the GpyFn has a DP within the range of 31-35;
1-10%, preferably 2-6% of the GpyFn has a DP within the range of 36-40;
0.5-8%, preferably 0.5-4% of the GpyFn has a DP within the range of 41-45;
0.5-10%, preferably 1-6% of the GpyFn has a DP within the range of 46-64;
0.1-4%, preferably 0.2-3% of the GpyFn has a DP of more than 64.

In preferred embodiments, the chain length distribution of the GpyFn comprised in the inulin composition has all of the following characteristics:
more than 10%, preferably more than 20% of the GpyFn has a DP within the range of 3-10;
more than 10%, preferably more than 20% of the GpyFn has a DP of more than 15.

In preferred embodiments, the chain length distribution of the GpyFn in the inulin composition has one, two or three of the following characteristics:
more than 0.3%, preferably more than 0.5%, more preferably more than 1% of the GpyFn has a DP of 3;
more than 0.5%, preferably more than 1%, more preferably more than 2% of the GpyFn has a DP of 4;
more than 0.7%, preferably more than 1.7%, more preferably more than 2.5% of the GpyFn has a DP of 5.

In embodiments, the GpyFn comprised in the inulin composition has a chain length distribution wherein every DP within the range of 3-60, preferably within the range of 3-40, preferably within the range of 3-30 is present in an amount of at least 0.1%, preferably at least 1%.

In embodiments, the inulin composition comprises less than 1 wt. % (by weight of inulin), preferably less than 0.5 wt. %, more preferably less than 0.2 wt. % of sugars.

In embodiments, the inulin composition comprises less than 0.4 wt. % (by weight of inulin), preferably less than 0.2 wt. %, more preferably less than 0.1 wt. % of sesquiterpene lactones.

In embodiments, less than 10 wt. % (by weight of the sesquiterpene lactones), preferably less than 5 wt. % of the sesquiterpene lactones comprised in the inulin composition are lactucins.

In embodiments, the inulin composition comprises less than 3 wt. % (by weight of inulin), preferably less than 1.5 wt. % of minerals. In embodiments, the inulin composition comprises more than 0.1 wt. % (by weight of inulin), preferably more than 0.8 wt. % of minerals.

In embodiments, the inulin composition comprises less than 2.5 wt. % (by weight of inulin), preferably less than 1.5 wt. % of organic acids, wherein the organic acids are preferably chosen from the group consisting of citric acid, malic acid, lactic acid, formic acid, acetic acid, propionic acid, butyric acid and combinations thereof. In embodiments, the inulin composition comprises more than 0.1 wt. % (by weight of inulin), preferably more than 0.8 wt. % of organic acids, wherein the organic acids are preferably chosen from the group consisting of citric acid, malic acid, lactic acid, formic acid, acetic acid, propionic acid, butyric acid and combinations thereof.

In embodiments, the inulin composition comprises less than 0.05 wt. % (by weight of inulin), preferably less than 0.03 wt. % of polyphenols. In embodiments, the inulin composition comprises more than 0.005 wt. % (by weight of inulin), preferably more than 0.01 wt. % of polyphenols.

In a very preferred embodiment, the inulin composition comprises:
inulin, wherein more than 2%, preferably more than 4%, more preferably more than 6% of the inulin has a DP within the range of 3-5, said inulin comprising GpyFn inulins with a terminal glucose, wherein the GpyFn has a chain length distribution wherein every DP within the range of 3-60 is present in an amount of at least 0.1%, preferably at least 1%;
less than 0.1 wt. % (by weight of inulin), preferably less than 0.05 wt. %, more preferably less than 0.01 wt. % of lactucins;
less than 3 wt. % (by weight of inulin), preferably less than 2 wt. %, more preferably less than 1.5 wt. % of sugars;
less than 20 wt. % (by weight of inulin), preferably less than 10 wt. %, more preferably less than 5 wt. %, even more preferably less than 2 wt. % of FpyFn;
more than 0.1 wt. % (by weight of inulin), preferably more than 0.8 wt. % of minerals; and
more than 0.1 wt. % (by weight of inulin), preferably more than 0.8 wt. % of organic acids, wherein the organic acids are preferably chosen from the group consisting of citric acid, malic acid, lactic acid, formic acid, acetic acid, propionic acid, butyric acid and combinations thereof.

In a very preferred embodiment, the inulin composition as defined hereinbefore comprises one or more, such as two, three or all of the following:
less than 0.4 wt. % (by weight of inulin), preferably less than 0.2 wt. %, more preferably less than 0.1 wt. % of sesquiterpene lactones;
less than 3 wt. % (by weight of inulin), preferably less than 1.5 wt. % of minerals;
less than 2.5 wt. % (by weight of inulin), preferably less than 1.5 wt. % of organic acids, wherein the organic acids are preferably chosen from the group consisting of citric acid, malic acid, lactic acid, formic acid, acetic acid, propionic acid, butyric acid and combinations thereof;
less than 0.05 wt. % (by weight of inulin), preferably less than 0.03 wt. % of polyphenols;
more than 0.005 wt. % (by weight of inulin), preferably more than 0.01 wt. % of polyphenols.

### Hydrolyzed Inulin Compositions

As illustrated in the appending examples, the present inventors also envisage the inulin composition of the present invention being subjected to a hydrolysis treatment to yield a unique hydrolyzed inulin composition. As is known to the skilled person, hydrolysis treatment may result in an increase in sugar content. Hence, the hydrolyzed inulin compositions of the present invention may have a higher sugar content than the inulin compositions before hydrolysis treatment. The wording ‘by weight of hydrolyzed inulin’ as used herein refers to inulin and not also to sugars that may form during hydrolysis.

In embodiments, the method of the present invention further comprises subjecting the retentate collected in step c) and/or the concentrate of step d) to chemical or enzymatic hydrolysis treatment, preferably enzymatic hydrolysis treatment, resulting in an increase in FpyFn content, such that a hydrolyzed inulin composition comprising more than 20 wt. % (by weight of inulin), preferably more than 40 wt. %, more preferably more than 60 wt. % of FpyFn is obtained.

In another aspect, the present invention provides a hydrolyzed inulin composition obtained by or obtainable by the method for producing the hydrolyzed inulin composition.

In another aspect, the invention provides a hydrolyzed inulin composition which comprises:
less than 0.1 wt. % (by weight of hydrolyzed inulin), preferably less than 0.05 wt. %, more preferably less than 0.01 wt. % of lactucins;
less than 5 wt. % (by weight of hydrolyzed inulin), preferably less than 2 wt. %, more preferably less than 1.5 wt. % of sugars;
more than 20 wt. % (by weight of hydrolyzed inulin), preferably more than 40 wt. %, more preferably more than 60 wt. % of FpyFn;
   and wherein
more than 20%, preferably more than 40%, more preferably more than 50% of the FpyFn comprised in the hydrolyzed inulin composition has a DP within the range of 3-5; and
more than 10%, preferably more than 25%, more preferably more than 40% of the FpyFn comprised in the hydrolyzed inulin composition has a DP of 3.

In highly preferred embodiments, less than 20%, more preferably less than 10%, more preferably less than 5%, most preferably less than 1% of the inulin comprised in the hydrolyzed inulin composition has a DP of more than 10.

In highly preferred embodiments, less than 20%, more preferably less than 10%, more preferably less than 5%, most preferably less than 1% of the FpyFn comprised in the hydrolyzed inulin composition has a DP of more than 10.

In embodiments, the hydrolyzed inulin composition comprises more than 1 wt. % (by total weight of the hydrolyzed inulin composition), preferably more than 5 wt. %, more preferably more than 10 wt. % of GpyFn.

In embodiments, the hydrolyzed inulin composition comprises more than 1 wt. % (by total weight of the hydrolyzed inulin composition), preferably more than 5 wt. %, more preferably more than 10 wt. % of FpyFn.

In embodiments, the hydrolyzed inulin composition has a dry-matter content of more than 40% (w/v), more preferably more than 60% (w/v).

In embodiments, the hydrolyzed inulin composition comprises more than 1 wt. % (by total weight of the inulin composition), preferably more than 5 wt. %, more preferably more than 10 wt. % of inulin.

In embodiments, the hydrolyzed inulin composition is in the form of an aqueous solution or syrup comprising 50-90 wt. % (by total weight of the aqueous solution or syrup), preferably 65-85 wt. % inulin and which has a dry matter content of less than 85% (w/v), preferably less than 80% (w/v).

In embodiments, the GpyFn comprised in the hydrolyzed inulin composition has a number-average degree of polymerization in the range of 3-12, preferably within the range of 3-10, preferably within the range of 3-7.

In embodiments, the FpyFn comprised in the hydrolyzed inulin composition has a number-average degree of polymerization in the range of 3-12, preferably within the range of 3-8, preferably within the range of 3-6.

In preferred embodiments, the chain length distribution of the GpyFn in the hydrolyzed inulin composition has one, two or three of the following characteristics:
more than 2%, preferably more than 5%, more preferably more than 8% of the GpyFn has a DP of 3;
more than 10%, preferably more than 15%, more preferably more than 20% of the GpyFn has a DP of 4;
more than 12%, preferably more than 20%, more preferably more than 25% of the GpyFn has a DP of 5.

In preferred embodiments, the chain length distribution of the FpyFn in the hydrolyzed inulin composition has one, two or three of the following characteristics:
more than 25%, preferably more than 35%, more preferably more than 40% of the FpyFn has a DP of 3;
more than 10%, preferably more than 15%, more preferably more than 20% of the FpyFn has a DP of 4;
more than 5%, preferably more than 10%, more preferably more than 15% of the FpyFn has a DP of 5.

In embodiments, the hydrolyzed inulin composition comprises less than 1 wt. % (by weight of hydrolyzed inulin), preferably less than 0.5 wt. %, more preferably less than 0.2 wt. % of sugars.

In embodiments, the hydrolyzed inulin composition comprises less than 0.4 wt. % (by weight of hydrolyzed inulin), preferably less than 0.2 wt. %, more preferably less than 0.1 wt. % of sesquiterpene lactones.

In embodiments, less than 10 wt. % (by weight of the sesquiterpene lactones), preferably less than 5 wt. % of the sesquiterpene lactones comprised in the hydrolyzed inulin composition are lactucins.

In embodiments, the hydrolyzed inulin composition comprises less than 3 wt. % (by weight of hydrolyzed inulin), preferably less than 1.5 wt. % of minerals. In embodiments, the hydrolyzed inulin composition comprises more than 0.1 wt. % (by weight of hydrolyzed inulin), preferably more than 0.8 wt. % of minerals.

In embodiments, the hydrolyzed inulin composition comprises less than 2.5 wt. % (by weight of hydrolyzed inulin), preferably less than 1.5 wt. % of organic acids, wherein the organic acids are preferably chosen from the group consisting of citric acid, malic acid, lactic acid, formic acid, acetic acid, propionic acid, butyric acid and combinations thereof. In embodiments, the hydrolyzed inulin composition comprises more than 0.1 wt. % (by weight of hydrolyzed inulin), preferably more than 0.8 wt. % of organic acids, wherein the organic acids are preferably chosen from the group consisting of citric acid, malic acid, lactic acid, formic acid, acetic acid, propionic acid, butyric acid and combinations thereof.

In embodiments, the hydrolyzed inulin composition comprises less than 0.05 wt. % (by weight of hydrolyzed inulin), preferably less than 0.03 wt. % of polyphenols. In embodiments, the hydrolyzed inulin composition comprises more than 0.005 wt. % (by weight of hydrolyzed inulin), preferably more than 0.01 wt. % of polyphenols.

In a preferred embodiment, the hydrolyzed inulin composition comprises:
less than 0.1 wt. % (by weight of hydrolyzed inulin), preferably less than 0.05 wt. %, more preferably less than 0.01 wt. % of lactucins;
less than 5 wt. % (by weight of hydrolyzed inulin), preferably less than 2 wt. %, more preferably less than 1.5 wt. % of sugars;
more than 20 wt. % (by weight of hydrolyzed inulin), preferably more than 40 wt. %, more preferably more than 60 wt. % of FpyFn;
more than 0.1 wt. % (by weight of hydrolyzed inulin), preferably more than 0.8 wt. % of minerals; and
more than 0.1 wt. % (by weight of hydrolyzed inulin), preferably more than 0.8 wt. % of organic acids, wherein the organic acids are preferably chosen from the group consisting of citric acid, malic acid, lactic acid, formic acid, acetic acid, propionic acid, butyric acid and combinations thereof.

In a preferred embodiment, the hydrolyzed inulin composition as defined hereinbefore comprises one or more, such as two, three or all of the following:
less than 0.4 wt. % (by weight of hydrolyzed inulin), preferably less than 0.2 wt. %, more preferably less than 0.1 wt. % of sesquiterpene lactones;
less than 3 wt. % (by weight of hydrolyzed inulin), preferably less than 1.5 wt. % of minerals;
less than 2.5 wt. % (by weight of hydrolyzed inulin), preferably less than 1.5 wt. % of organic acids, wherein the organic acids are preferably chosen from the group consisting of citric acid, malic acid, lactic acid, formic acid, acetic acid, propionic acid, butyric acid and combinations thereof;
less than 0.05 wt. % (by weight of hydrolyzed inulin), preferably less than 0.03 wt. % of polyphenols;
more than 0.005 wt. % (by weight of hydrolyzed inulin), preferably more than 0.01 wt. % of polyphenols.

### Alimentary Products

In another aspect of the invention, an alimentary product comprising the inulin composition, the inulin composition obtained by or obtainable by the method for purifying the aqueous liquid comprising inulin described herein, the hydrolyzed inulin composition, or the hydrolyzed inulin composition obtained by or obtainable by the method for purifying an aqueous liquid comprising inulin, all as defined hereinbefore, is provided.

In an embodiment, the alimentary product is selected from the group consisting of dairy products, frozen desserts, table spreads, baked goods, breads, breakfast cereals, fillings, fruit preparations, salad dressings, meat products, dietetic products, meal replacers and chocolate.

### Applications

In another aspect of the invention, different uses of the inulin composition or the hydrolyzed inulin composition as defined hereinbefore and of the inulin composition or the hydrolyzed inulin composition obtained by or obtainable by the methods as described hereinbefore are provided.

In an embodiment, the use of said inulin composition or said hydrolyzed inulin composition as a prebiotic agent is provided.

In an embodiment, the use of said inulin composition or said hydrolyzed inulin composition to increase the carbohydrate fiber content of an alimentary product is provided.

In an embodiment, the use of said inulin composition or said hydrolyzed inulin composition as a carbohydrate fiber in an alimentary product is provided.

In an embodiment, the use of said inulin composition or said hydrolyzed inulin composition as a gelling agent is provided.

In an embodiment, the use of said inulin composition or said hydrolyzed inulin composition as a fat replacer is provided, for example in low-fat foods.

In an embodiment, the use of said inulin composition or said hydrolyzed inulin composition as a sugar replacer is provided.

In an embodiment, the use of said inulin composition or said hydrolyzed inulin composition to improve taste is provided.

In an embodiment, the use of said inulin composition or said hydrolyzed inulin composition as a texture enhancer is provided.

In an embodiment, the use of said inulin composition or said hydrolyzed inulin composition to improve the mouthfeel of an alimentary product is provided.

In an embodiment, the use of said inulin composition or said hydrolyzed inulin composition as a foam stabilizer is provided.

In an embodiment, the use of said inulin composition or said hydrolyzed inulin composition to improve the melting behaviour of an alimentary product is provided.

In an embodiment, the use of said inulin composition or said hydrolyzed inulin composition to improve the spreadability of an alimentary product is provided.

In an embodiment, the use of said inulin composition or said hydrolyzed inulin composition as an emulsion stabilizer is provided.

In an embodiment, the use of said inulin composition or said hydrolyzed inulin composition to improve the moisture retention of an alimentary product is provided.

In an embodiment, the use of said inulin composition to improve the crispness of an alimentary product is provided.

In an embodiment, the use of said inulin composition or said hydrolyzed inulin composition to improve the heat resistance of an alimentary product is provided.

### Examples

### Preparation of Feed Stream

Several different batches of an aqueous solution comprising inulin, to be used as a feed stream in the nanofiltration experiments, were prepared. For each batch, Cichorium intybus L. var. sativum DC roots were washed to remove soil, rocks etc. and sliced to thin strips/cossettes using a drum slicer. The chicory root strips were subject to counter-current extraction using water at 70° C. The extract was subsequently submitted to the protein removal step as detailed in table 1, to obtain an aqueous solution comprising inulin, lactucins, sugar and processed plant material, which was used as the feed stream for the nanofiltration experiments.

The composition of the different batches obtained is further detailed in table 2. Differences in composition of the batches are due to natural variations in chicory root composition due to different harvest times for different batches.

TABLE 1
feed stream preparation

| | | Inulin |
|---|---|---|
| | | content |
| Batch: | Protein removal step | (g/kg) |
| 1 | Flocculation followed by decantation and | 115.6 |
| | centrifugation | |
| 2 | Flocculation followed by decantation and | 118.9 |
| | centrifugation | |
| 3 | Flocculation followed by decantation and | 113.4 |
| | centrifugation | |
| 4 | Flocculation followed by decantation and | 117.8 |
| | centrifugation | |
| 5 | Microfiltration | 110.6 |

TABLE 2
feed stream composition in wt. % (by weight of inulin) after protein removal step and before nanofiltration.

| | | | | | Sesquiterpene | | organic | | | |
|---|---|---|---|---|---|---|---|---|---|---|
| Batch | Sugars | DP3 | DP4 | DP5 | lactons | Minerals | acids | lactucins | lactucopicrins | polyphenols |
| 1 | 5.19 | 1.82 | 2.51 | 2.77 | 0.61 | not | not | 0.062 | 0.552 | not |
| | | | | | | determined | determined | | | determined |
| 2 | 5.89 | 2.10 | 3.03 | 3.36 | 0.75 | 4.00 | 3.34 | 0.076 | 0.676 | 0.15 |
| 3 | 9.44 | 3.44 | 4.41 | 4.41 | 0.83 | 4.40 | 3.30 | 0.049 | 0.778 | 0.17 |
| 4 | 8.91 | 3.57 | 4.75 | 4.92 | 0.49 | 5.39 | 3.23 | 0.070 | 0.423 | 0.15 |
| 5 | 9.13 | 4.16 | 5.52 | 5.61 | 0.52 | 5.69 | 3.22 | 0.108 | 0.411 | 0.20 |

### Nanofiltration Experiments

Nanofiltration experiments were performed on a pilot-scale in-house built membrane skid (with 2*2.5′ modules to support 2*2 m² membrane) crossflow spiral wound nanofiltration setup equipped with a 46 mils diamond spacer using the membranes detailed in the below table. New/unused membranes were first washed with process water at 20° C. and 5 bar retentate pressure. Next, the membranes were washed with demineralized water at 20° C. and 5 bar retentate pressure at a circulation rate of 360 l/hour.

TABLE 3
nanofiltration membrane specifications

| | | | Membrane area |
|---|---|---|---|
| Membrane | Type/specifications | Supplier | (m²) |
| NFG | PA-TFC | Synder | 3.6 |
| | 600-800 Da | | |
| NP010 | PES | Microdin Nadir | 3.6 |
| | 1 kDa | | |
| XT | PA-TFC | Synder | 4.09 |
| | 1 kDa | | |

Several different experiments were performed, as detailed in table 4 below. The experiment number corresponds to the batch number of the feed stream employed in the experiment. All experiments were performed employing a feed stream volume of 100 l.

Analysis of the retentate stream was performed at different W/F factors to monitor the purification process. Table 5 shows the evolution of the selectivity, flux, inulin and sesquierpene lactone concentrations as a function of the W/F factor.

TABLE 4
Experimental setup

| | | T | Approximate transmembrane |
|---|---|---|---|
| Exp | Membrane | (° C.) | pressure (bar) |
| 1 | NFG | 40 | 22 |
| 2 | NP010 | 60 | 22 |
| 3 | XT | 50 | 8 |
| 4 | XT | 40 | 6 |
| 5 | NP010 | 60 | 22 |

TABLE 5
evolution of inulin and sesquierpene lactone concentrations during diafiltration.

| | | Inulin | | | Sesquiterpene | | | | |
|---|---|---|---|---|---|---|---|---|---|
| | | concentration | | | lactones | | | | |
| | | (wt. % by total | Inulin | Retention | (wt. % by total | Sesquiterpene | Retention | Flux | Selectivity |
| Batch | W/F | weight of retentate) | yield (%) | (%) | weight of retentate) | lactone yield (%) | (%) | (I/(m^{2*}hour)) | (S) |
| 1 | 0 | 11.56 | 100.00 | 100.00 | 0.07 | 100.00 | 100.00 | 40.83 | 13.7 |
| 1 | 1 | 11.47 | 99.22 | 99.22 | 0.06 | 82.68 | 80.98 | 40.56 | 7.6 |
| 1 | 2 | 11.28 | 97.58 | 99.16 | 0.05 | 75.35 | 95.36 | 29.17 | 5.5 |
| 1 | 2.5 | 11.28 | 97.58 | 100.00 | 0.05 | 70.99 | 97.61 | 20.00 | 5.1 |
| 1 | 2.9 | 11.14 | 96.37 | 99.57 | 0.05 | 68.59 | 98.82 | 12.78 | 4.0 |
| 2 | 0 | 11.89 | 100.00 | 100.00 | 0.09 | 100.00 | 100.00 | 27.78 | 6.1 |
| 2 | 1 | 10.90 | 91.67 | 91.31 | 0.04 | 48.43 | 27.50 | 26.39 | 7.4 |
| 2 | 2 | 10.42 | 87.64 | 97.75 | 0.02 | 23.60 | 64.06 | 25.00 | 14.1 |
| 2 | 3 | 9.85 | 82.84 | 98.12 | 0.01 | 13.65 | 81.74 | 23.61 | 14.2 |
| 2 | 4 | 9.82 | 82.59 | 99.92 | 0.01 | 7.94 | 86.47 | 22.22 | 15.7 |
| 2 | 5 | 9.08 | 76.37 | 98.43 | 0.00 | 4.92 | 90.43 | 20.56 | 17.9 |
| 3 | 0 | 11.34 | 100.00 | 100.00 | 0.09 | 100.00 | 100.00 | 45.75 | 3.2 |
| 3 | 1 | 9.19 | 81.04 | 78.98 | 0.04 | 43.33 | 16.37 | 46.24 | 5.7 |
| 3 | 2 | 8.04 | 70.90 | 93.32 | 0.02 | 18.89 | 58.49 | 47.46 | 7.3 |
| 3 | 3 | 6.89 | 60.76 | 94.85 | 0.01 | 9.28 | 76.33 | 49.17 | 7.8 |
| 3 | 4 | 6.36 | 56.08 | 98.00 | 0.00 | 4.70 | 82.96 | 50.15 | 8.5 |
| 3 | 5 | 5.71 | 50.35 | 98.23 | 0.00 | 2.24 | 93.00 | 26.91 | 8.9 |
| 4 | 0 | 11.78 | 100.00 | 100.00 | 0.06 | 100.00 | 100.00 | 32.54 | 2.2 |
| 4 | 1 | 8.63 | 73.26 | | 0.02 | 42.00 | | 32.54 | 3.8 |
| 4 | 2 | 7.24 | 61.46 | | 0.01 | 17.38 | | 32.54 | 6.2 |
| 4 | 3 | 6.18 | 52.46 | | 0.00 | 7.92 | | 32.54 | 4.4 |
| 5 | 0 | 11.06 | 100.00 | 100.00 | 0.06 | 100.00 | 100.00 | 31.39 | |
| 5 | 1 | 9.58 | 86.62 | | 0.03 | 52.79 | | 27.22 | |
| 5 | 2 | 8.71 | 78.75 | | 0.02 | 29.62 | | 26.67 | |
| 5 | 3 | 8.06 | 72.88 | | 0.01 | 17.42 | | 25.28 | |
| 5 | 4 | 7.55 | 68.26 | | 0.01 | 10.28 | | 23.89 | |
| 5 | 5 | 7.18 | 64.92 | | 0.00 | 6.62 | | 22.50 | |

Table 6 shows the composition of the retentate stream at the end of each diafiltration experiment.

TABLE 6
retentate stream composition after nanofiltration in diafiltration mode in wt. % (by weight of inulin).

| | | Inulin | | | | | | | | | | |
|---|---|---|---|---|---|---|---|---|---|---|---|---|
| | | content | | | | | Sesquiterpene | | organic | | | |
| Batch | W/F | (g/kg) | Sugars | DP3 | DP4 | DP5 | lactons | minerals | acids | lactucins | lactucopicrins | polyphenols |
| 1 | 2.9 | 111.4 | 1.17 | 1.44 | 2.24 | 2.69 | 0.44 | n/a | n/a | 0.035 | 0.402 | n/a |
| 2 | 5 | 90.8 | 0.11 | 0.99 | 1.32 | 1.87 | 0.05 | 0.49 | 0.61 | 0.002 | 0.046 | 0.01 |
| 3 | 5 | 57.1 | 0.18 | 0.18 | 0.35 | 0.35 | 0.04 | 0.30 | 0.27 | 0.000 | 0.037 | 0.01 |
| 4 | 3 | 61.8 | 0.97 | 0.49 | 0.81 | 1.13 | 0.07 | 0.97 | 0.52 | 0.006 | 0.068 | 0.02 |
| 5 | 5 | 75.5 | 1.46 | 1.06 | 2.25 | 2.91 | 0.05 | 1.15 | 0.99 | 0.005 | 0.045 | 0.02 |

### Preparation of Inulin Concentrate in Powder-Form

The retentate streams of batches 2 and 5 obtained after nanofiltration in diafiltration mode with W/F=5 were subjected to evaporation and freeze-drying to yield inulin compositions in accordance with the invention in the form of a concentrate which is a powder with an inulin content of 95.2 wt. % (batch 2) or 95.0 wt. % (batch 5) and a dry-matter content of 96.3 wt. % (batch 2) or 97.4 wt. % (batch 5). The chain length distribution of these freeze dried inulin compositions was determined and is shown in the below table.

| Inulin | Batch 2 (% of inulin) | Batch 5 (% of inulin) |
|---|---|---|
| DP3-DP10 | 23.6 | 31.6 |
| DP11-DP15 | 20.8 | 23.7 |
| DP16-DP20 | 16.7 | 16.9 |
| DP21-DP25 | 11.9 | 10.5 |
| DP26-DP30 | 8.2 | 6.4 |
| DP31-DP35 | 5.9 | 4.0 |
| DP36-DP40 | 3.9 | 2.4 |
| DP41-DP45 | 2.7 | 1.5 |
| DP46-DP64 | 4.4 | 1.9 |
| >DP64 | 1.2 | 0.4 |

### Preparation and Concentration of Hydrolyzed Inulin Composition

Hydrolyzed inulin compositions were prepared from batch 2 and 5 by concentrating 10 l of the retentate streams (by evaporation) to a concentration of 25 brix. Inulase Novozyme 960 was added and after 24 hours at 60° C. the resulting solution was concentrated (by evaporation) to a hydrolyzed inulin composition in accordance with the invention in the form of a concentrate which is a syrup. The concentration of the syrup was 74,2 brix (batch 2).

The chain length distribution of these hydrolyzed inulin compositions was determined and is shown in the below table.

| GpyFn | FpyFn | Batch 2 (% of inulin) | Batch 5 (% of inulin) |
|---|---|---|---|
| DP3 | | 2.7 | 1.4 |
| (GF2) | | | |
| DP4 | | 6.7 | 5.7 |
| (GF3) | | | |
| | DP3 (F3) | 28.0 | 25.9 |
| DP5 | | 8.0 | 10.1 |
| (GF4) | | | |
| | DP4 (F4) | 15.8 | 21.1 |
| DP6 | | 7.4 | 8.5 |
| (GF5) | | | |
| | DP5 (F5) | 11.2 | 9.6 |
| DP7 | | 1.6 | 5.4 |
| (GF6) | | | |
| | DP6 (F6) | 6.4 | 5.5 |
| DP8 | | 1.0 | 0.4 |
| (GF7) | | | |
| | DP7 (F7) | 1.1 | 2.1 |
| DP9 | | 0.8 | 0.5 |
| (GF8) | | | |

| | | |
|---|---|---|
| DP10 (inulin) | 0.4 | 0.4 |
| >DP10 (inulin) | 0.4 | 0.9 |

### Taste and Colour Evaluation

The inulin compositions in powder form and the hydrolyzed inulin compositions in syrup form were all evaluated for taste and colour by a 12 person panel. Very limited to no bitter taste was observed, leading the test panel to conclude that all samples had satisfactory taste. The inulin compositions in powder form were observed to be white to slightly off-white, leading the test panel to conclude that all samples had satisfactory colour.

Thus, it has been shown that the process in accordance with the present invention, effectively provides a method for purifying an aqueous liquid comprising inulin and one or both of lactucins and sugars, wherein said inulin comprises a significant amount of low DP inulin, resulting in an inulin composition which has low sugar content and desirable taste (low lactucins/sesquiterpene lactones), while the purification method preserves the low DP inulins.

### Analysis Methods

The concentrations of the different components provided in the experimental section and anywhere else herein, have been determined in accordance with the below analysis protocols. HP/C-CD protocol: Chloride, bromide, nitrate, malate, sulfate, oxalate and phosphate concentrations were determined using high pressure ion chromatography coupled to a conductivity detector (HPIC-CD). A calibration curve was constructed by analysing a series of dilutions of a stock solution containing chloride, bromide, nitrate, phosphate, malate, sulfate and oxalate (100 mg/kg each in demineralized water). Measurements were performed using the following setup (employing a KOH gradient in the eluent).

| | |
|---|---|
| Autosampler | Thermo AS-AP |
| Injection volume | 7 μL |
| Injector temperature | 10° C. |
| Pump flow | 0.38 ml/min |
| Eluent generator | EGC 500 KOH |
| Column | Dionex IonPac AS11-HC-4 μm |
| Max. pressure | 5000 psi |
| Column temperature | 30° C. |
| Supressor | AERS-500 2 mm |
| Supressor current | 52 mA |
| Detector | Thermo Fisher Scientific |
| | Integrion Analytical CD |
| Detector temperature | 35° C. |
| Analysis time | 37.5 min |

| | Time | Concentration (mM |
|---|---|---|
| Step | (min) | KOH) |
| 1 | 0 | 10 |
| 2 | 8 | 10 |
| 3 | 21 | 26.25 |
| 4 | 33 | 50 |
| 5 | 33 | 75 |
| 6 | 35 | 75 |
| 7 | 35 | 10 |
| 8 | 37.5 | 10 |

ICP-AES protocol: sodium, potassium, calcium and magnesium concentrations were determined using inductively coupled plasma—atomic emission spectroscopy (IPC-AES) analysis.

Analyte samples were acidified using HNO₃ and measured in a type Thermo Fisher Scientific iCap 6000 series ICP emission spectrometer using 1150 W RF power. The following solutions (acidified using HNO₃) were used for calibration purposes.

| Stock | Ca | K | Mg | Na |
|---|---|---|---|---|
| solution | (mg/kg) | (mg/kg) | (mg/kg) | (mg/kg) |
| blank | 0 | 0 | 0 | 0 |
| 1 | 1.25 | 25 | 1.25 | 25 |
| 2 | 2.50 | 50 | 2.50 | 50 |
| 3 | 3.75 | 100 | 3.75 | 100 |
| 4 | 5 | 150 | 5 | 150 |

GPC-RI protocol: monosaccharides, disaccharides, DP3 inulin, DP4 inulin, DP5 inulin and >DP5 inulin were determined using gel permeation chromatography coupled to a refractive index detector (GPC-RI). A calibration solution was prepared containing 0.5% (w/v) fructose, 0.5% (w/v) glucose, 0.5% (w/v) sacharose. Another calibration solution containing an in-house inulin/polyfructofuranose reference standard was prepared. Calibration curves were constructed by analysing a series of dilutions of the calibration solutions. Sample peaks in the chromatogram were integrated manually after visual inspection in order to prevent acids and salts to be interpreted as inulin. Measurements were performed using the following setup.

| | |
|---|---|
| Injection volume | 20 μl |
| Column | Shodex KS-802, 300 × 8 mm |
| Guard column | Shodex KS-800P 50 × 6 mm |
| Column temperature | 50° C. |
| Max. pressure | 50 bar |
| Eluent | MilliQ water |
| Flow | 1.0 ml/min |
| Detector | Shodex RI-101, max range |
| Detector temperature | 35° C. |

HPAEC-PAD protocol: the chain length distribution of inulin was determined using high performance anion exclusion chromatography coupled to pulsed amperometric detection (HPAEC-PAD). Inulin samples were stabilized using 1 ml NaOH (1M) and diluted to 1% (w/v) inulin. After heating in a hot water bath until all inulin is dissolved, the hot sample is filtered over a 0.45 μm membrane filter and diluted 10× for analysis. Hydrolyzed inulin samples were diluted to 1% (w/v) and diluted 50× for analysis. Inulin response factors according to Timmermans et al. (Timmermans, J. W., van Leeuwen, M. B., Tournois, H., de Wit, D. and Vliegenthart, J. F. G. (1994) ‘Quantitative Analysis of the Molecular Weight Distribution of Inulin by Means of Anion Exchange HPLC with Pulsed Amperometric Detection’, Journal of Carbohydrate Chemistry, 13:6, 881-888) were used. Measurements were performed using a Thermo Fishre Scientific, ICS 5000 ED using the following setup. Chain length distribution was expressed in % of inulin/GpyFn/FpyFn of a specific chain length, wherein the % is calculated based on peak surface area for that chain length compared to total peak surface area.

| | |
|---|---|
| Injection volume | 10 μl |
| Column | CarboPac PA200 Analytical (3 × 250 mm) |
| Max. pressure | 4000 psi |
| Flow | 0.5 ml/min |
| Temperature | 20° C. |
| Detector | 30° C., Carbohydrate waveform, Ag/AgCl |
| | reference |

Gradient (Inulin Sample)

| | A [%] | | C [%] | |
|---|---|---|---|---|
| | (demineralized | B [%] | (1M NaAc + | Flow |
| Tijd | water) | (0.10M NaOH) | 0.10M NaOH) | ml/min |
| −5 | 0 | 100 | 0 | 0.5 |
| 0 | 0 | 100 | 0 | 0.5 |
| 60 | 0 | 50 | 50 | 0.5 |
| 61 | 0 | 100 | 0 | 0.5 |
| 0 | 0 | 100 | 0 | 0.5 |

Gradient (Hydrolyzed Inulins Sample)

| | A [%] | | C [%] | |
|---|---|---|---|---|
| | (demineralized | B [%] | (1M NaAc + | Flow |
| Tijd | water) | (0.10M NaOH) | 0.10M NaOH) | ml/min |
| 0 | 0 | 100 | 0 | 0.5 |
| 35 | 0 | 70 | 30 | 0.5 |
| 36 | 0 | 100 | 0 | 0.5 |

HPLC-CD protocol: citric acid, malic acid, lactic acid, formic acid, acetic acid, propionic acid and butyric acid were determined using high pressure liquid chromatography coupled to a conductivity detector (HPLC-CD). A calibration solution was prepared containing the following components.

| Component | concentration (mg/l) |
|---|---|
| Citric acid | 300 |
| malic acid | 300 |
| lactic acid | 750 |
| formic acid | 300 |
| acetic acid | 500 |
| pyrrolidon carboxylic | 750 |
| acid | |
| propionic acid | 750 |
| butyric acid | 750 |

2.5 ml 50% NaOH was added to 11 of calibration solution. A calibration curve was constructed by analysing a dilution series of the calibration solution. Measurements were performed using the following setup.

| | |
|---|---|
| Suppressor liquid | 10 mM ammonium hydroxide |
| Flow suppressor | 2 ml/min |
| Eluent | 1.6 mM Heptafluorbutyric acid |
| Column oven | 45° C. |
| Column | Biorad Aminex HPX-87H, 300 × 7.8 mm |
| Flow column | 0.6 ml/min |
| Max. Pressure | 100 bar |
| Injector volume | 20 μl |
| Detector | 200 μS, SRS 0 |

UHPLC-MS protocol: lactucin, dihydro-lactucin, 8-deoxylactucin-15-oxalate, 8-deoxylactucin, dihydro-8-deoxylactucin, lactucopicrin-15-oxalate, dihydro-lactucopicrin-oxalate, dihydro-lactucopicrin and lactucopicrin were determined using ultra high pressure liquid chromatography coupled to mass spectrometry (UHPLC-MS). A calibration curve was constructed by analysing a dilution series of a calibration solution containing an in-house sesquiterpene lactones standard. 1 ml sample was diluted with 3 ml MeOH (5% acetic acid), and 1 ml sesquiterpene lactones standard was added. Measurements were performed using an Agilent® 1260 UHPLC coupled to an Agilent®6420 ESI-QQQ-MS (electron spray ionization—triple quad—mass spectrometer) using the following setup. Quantitative calculations were made using Agilent Masshunter software.

UHPLC

| | |
|---|---|
| Pump | flow 0.4 ml/min |
| Injection volume | 5 μl |
| Eluent | Acetonitril (0.1% acetic acid) gradient: |
| | 1-8 min: 20→ 50% ACN |
| | 8-9 min: 50% ACN |
| | 8-9 min: 50→ 20% ACN |
| | Runtime: 12 min |
| Column oven temperature | 40° C. |

MS

| | |
|---|---|
| Mode | MRM |
| Polarity | Positive + Negative |
| Delta EMV (+) | 200 |
| Delta EMV (−) | 200 |
| Gas temperature | 300° C. |
| Gas flow | 11 l/min |
| Nebulizer | 45 psi |
| Capillary | 3000 V |

LC-MS protocol: 4-O-caffeoylquinate, chlorogenic acid, caffeic acid and cichoric acid were determined using liquid chromatography coupled to UV (330 nm) and subsequent mass spectrometry detection (LC-MS). Samples were diluted using 0.1% formic acid in water. Measurements were performed using an Agilent 1260 with the following setup.

| | |
|---|---|
| Column | Poroshell 120 SB-C18 (2.1 × 150 mm, 2.7 μm, |
| | Agilent |
| Column temperature | 25° C. |
| Eluent A | 0.1% formic acid in water |
| Eluent B | Acetonitrile |
| Injection volume | 5 μl |

### Gradient

| Time | | | Flow |
|---|---|---|---|
| (min) | % A | % B | (mL/min) |
| 0 | 95 | 5 | 0.30 |
| 1 | 92 | 8 | 0.30 |
| 2 | 89 | 11 | 0.30 |
| 3 | 85 | 15 | 0.30 |
| 5 | 84 | 16 | 0.30 |
| 9 | 83 | 17 | 0.30 |
| 10 | 82 | 18 | 0.30 |
| 14 | 79 | 21 | 0.30 |
| 15 | 60 | 40 | 0.30 |
| 16 | 0 | 100 | 0.30 |
| 17 | 95 | 5 | 0.30 |
| 20 | 95 | 5 | 0.30 |

1. A method for purifying an aqueous liquid comprising inulin, said method comprising the steps of:
a) providing an aqueous liquid comprising:
inulin, wherein more than 5 wt. % (by weight of inulin) of the inulin has a DP within the range of 3-5, said inulin comprising GpyFn inulins with a terminal glucose, wherein the GpyFn inulins have a chain length distribution wherein every DP within the range of 3-60 is present in an amount of at least 0.1%;
lactucins in an amount of more than 0.1 wt. % (by weight of inulin);
sugars in an amount of more than 3 wt. % (by weight of inulin);
more than 3 wt. % (by weight of inulin) of minerals; and
more than 3 wt. % (by weight of inulin) of organic acids;
b) subjecting the aqueous liquid of step a) to a nanofiltration step employing a nanofiltration membrane having a molecular weight cut-off value of less than 2 kDa; and
c) collecting the retentate of nanofiltration step b) comprising:
inulin, wherein more than 2% (by weight of inulin) of the inulin has a DP within the range of 3-5, said inulin comprising GpyFn inulins with a terminal glucose, wherein the GpyFn inulins have a chain length distribution wherein every DP within the range of 3-60 is present in an amount of at least 0.1%;
less than 0.1 wt. % (by weight of inulin) of lactucins;
less than 3 wt. % (by weight of inulin) of sugars;
less than 20 wt. % (by weight of inulin) of FpyFn;
more than 0.1 wt. % (by weight of inulin) of minerals; and
more than 0.1 wt. % (by weight of inulin) of organic acids,
wherein the method does not comprise an ion-exchange treatment.

2. The method according to claim 1 wherein step a) comprises the following steps:
a1) providing a plant material comprising inulin, proteins, sugars and lactucins,
a2) subjecting the plant material to a processing step to provide an aqueous liquid comprising inulin, sugars, proteins and lactucins and processed plant material;
a3) separating the processed plant material and the aqueous liquid; and
a4) subjecting the aqueous liquid to a protein removal step wherein the proteins are at least partially removed to provide the aqueous liquid of step a).

3. The method according to claim 1 wherein step a) comprises the following steps:
a1) providing a plant material comprising inulin, proteins, sugars and lactucins;
a2) contacting the plant material with an aqueous extraction liquid for an amount of time sufficient to provide an aqueous extraction liquid comprising inulin, sugars, proteins and lactucins and processed plant material;
a3) separating the processed plant material and the aqueous extraction liquid; and
a4) submitting the aqueous extraction liquid to a protein removal step wherein the proteins are at least partially removed to provide the aqueous liquid of step a).

4. The method according to claim 1, wherein the aqueous liquid provided in step a) comprises more than 1 wt. % (by weight of aqueous liquid) of inulin.

5. The method according to claim 1, wherein the aqueous liquid provided in step a) comprises one or two of the following:
more than 0.4 wt. % (by weight of inulin) of sesquiterpene lactones;
more than 0.05 wt. % (by weight of inulin) of polyphenols.

6. The method according to claim 1, wherein the aqueous liquid provided in step a) has not been subjected to active carbon filtration prior to step b).

7. The method according to claim 1, wherein the nanofiltration membrane employed in step b) has a molecular weight cut-off value of more than 0.5 kDa.

8. The method according to claim 1, wherein the nanofiltration membrane employed in step b) comprises or consists of one or more polymers selected from the group consisting of polyamide (PA), polysulfone (PS), polyethersulfone (PES), polyimide, and polypiperazine.

9. The method according to claim 1, further comprising the step d) of concentrating the retentate obtained in step c) to provide an inulin concentrate with an inulin concentration of at least 20 wt. %.

10. The method according to claim 9 wherein step d) comprises or consists of evaporation and/or spray-drying.

11. The method according to claim 1, wherein the method does not comprise active carbon filtration.

12. The method according to claim 1, further comprising subjecting the retentate collected in step c) and/or the concentrate of step d) to chemical or enzymatic hydrolysis treatment, such that a hydrolyzed inulin composition comprising more than 20 wt. % (by weight of inulin) of FpyFn is obtained.

13. Inulin composition obtainable by the method according to claim 1.

14. Inulin composition which comprises:
inulin, wherein more than 2% of the inulin has a DP within the range of 3-5, said inulin comprising GpyFn inulins with a terminal glucose, wherein the GpyFn has a chain length distribution wherein every DP within the range of 3-60 is present in an amount of at least 0.1%;
less than 0.1 wt. % (by weight of inulin) of lactucins;
less than 3 wt. % (by weight of inulin) of sugars;
less than 20 wt. % (by weight of inulin) of FpyFn;
more than 0.1 wt. % (by weight of inulin) of minerals; and
more than 0.1 wt. % (by weight of inulin) of organic acids.

15. Inulin composition in accordance with claim 14 in the form of a spray-dried powder comprising more than 80 wt. % of inulin and which has a dry matter content of more than 80% (w/v).

16. Inulin composition in accordance with claim 14, which comprises more than 1 wt. % (by total weight of the inulin composition) of inulin.

17. Inulin composition in accordance with claim 14, which comprises one or more of the following:
less than 0.4 wt. % (by weight of inulin) of sesquiterpene lactones;
less than 3 wt. % (by weight of inulin) of minerals;
less than 2.5 wt. % (by weight of inulin) of organic acids;
less than 0.05 wt. % (by weight of inulin) of polyphenols;
more than 0.005 wt. % (by weight of inulin) of polyphenols.

18. Alimentary product comprising the inulin composition in accordance with claim 14.

19. (canceled)

20. The method of claim 1, wherein the organic acids are chosen from the group consisting of citric acid, malic acid, lactic acid, formic acid, acetic acid, propionic acid, butyric acid and combinations thereof.

21. The composition of claim 14, wherein the organic acids are chosen from the group consisting of citric acid, malic acid, lactic acid, formic acid, acetic acid, propionic acid, butyric acid and combinations thereof.
